(19) United States
(12) Patent Application Publication
(10) Pub. No.: US 2016/0010362 A1
(43) Pub. Date: Jan. 14, 2016

(54) FILE CABINET LATCH WITH WIRE RELEASE

(71) Applicant: Key Systems, Inc., Fishers, NY (US)

(72) Inventors: George H. Eckerdt, Victor, NY (US); George Mastrodonato, Rochester, NY (US)

(21) Appl. No.: 14/534,681

(22) Filed: Nov. 6, 2014

Related U.S. Application Data
(60) Provisional application No. 62/046,578, filed on Sep. 5, 2014.
(60) Provisional application No. 61/899,972, filed on Nov. 5, 2013.

(51) Int. Cl. E05B 65/46; E05B 47/00; G06F 21/86; A47B 63/02

(52) U.S. Cl. CPC E05B 65/462; A47B 63/02; E05B 47/0001; G06F 21/86

(57) ABSTRACT

A latch can keep a file cabinet drawer from being unlocked, but can allow unlocking of the drawer, such as if the user is authenticated when the latch is part of a secure asset management system, but can be overridden by a key lock of the file cabinet. A solenoid pin can interfere with translation of a slide to prevent unlocking of the drawer until energized, at which point a user can pull a tab attached to the slide to unlock the drawer. A spring can bias the slide into the file cabinet to automatically re-enable locking.

### BACKGROUND

The present invention relates to management and security of valuable assets, and, in particular, to securing, monitoring, and providing authorized access to a file cabinet or the like that can contain an asset.

A security asset management system (SAM) can use circuitry to monitor, secure, and/or manage assets, such as keys, computers, weapons, and/or any other object. In some implementations, a SAM can control access to rooms, vehicles, and/or other places and/or objects, directly and/or indirectly. By providing proper credentials, a user can be authenticated and can be granted access to one or more assets. Credentials can be provided directly or indirectly, such as via a keypad on a SAM device, by phoning credentials into a SAM control center, and/or a variety of other ways. Access to assets can thus be managed among and/or restricted to those with proper authorization from an owner and/or user.

### SUMMARY

According to one embodiment of the present invention, a file cabinet latch can include a first manual actuator configured to protrude from a file cabinet and to translate away from and toward the file cabinet. At least one mechanical linkage can be configured to operate a locking system of the file cabinet responsive to translation of the first manual actuator such that moving the first manual actuator away from the file cabinet unlocks at least one drawer of the file cabinet and moving the first manual actuator back toward the file cabinet locks any closed drawer of the file cabinet.

In another embodiment of the invention disclosed herein, a secure asset management system can have a controller that can include at least one computing device configured to receive an authentication request, receive authentication information, and grant access to an asset responsive to a match between the authentication information and an authentication reference. A user interface can be configured to allow interaction with the controller to request access to the asset and to provide the authentication information. A file cabinet can include a drawer in which the asset is stored, and a latch for the file cabinet, which can unlock the drawer responsive to the controller granting access to the asset

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing, and other features and advantages of the invention, are apparent from the following detailed description taken in conjunction with the accompanying drawings in which:

FIG. 1 is a schematic block diagram illustrating a secure asset management system with which embodiments of the invention disclosed herein can be used.

FIG. 2 is a schematic diagram illustrating a secure asset management system with which embodiments of the invention disclosed herein can be used.

FIG. 3 is a schematic elevational front view of a file cabinet including a latch according to embodiments of the invention disclosed herein.

FIG. 4 is a schematic back view of a file cabinet lock including aspects of embodiments of the invention disclosed herein.

FIG. 5 is a view of the file cabinet shown in FIG. 2 with drawers removed to show aspects of embodiments of the invention disclosed herein.

FIG. 6 is a view of a drawer sensor according to embodiments of the invention disclosed herein.

FIG. 7 is a side view illustrating a latch according to embodiments of the invention disclosed herein.

FIG. 8 is a view of a portion of a latch according to embodiments of the invention disclosed herein.

FIG. 9 is a view of a portion of a latch according to embodiments of the invention disclosed herein.

FIG. 10 is a top view of portions of a latch according to embodiments of the invention disclosed herein.

FIG. 11 is a side view of portions of a latch including a solenoid according to embodiments of the invention disclosed herein.

FIG. 12 is a side view of portions of a latch including a solenoid according to embodiments of the invention disclosed herein.

FIG. 13 is a side view of portions of a latch including a solenoid according to embodiments of the invention disclosed herein.

FIG. 14 is a top view of portions of a latch according to further embodiments of the invention disclosed herein.

FIG. 15 is a side view of portions of a latch including a solenoid according to further embodiments of the invention disclosed herein.

FIG. 16 is a side view of portions of a latch including a solenoid according to further embodiments of the invention disclosed herein.

FIG. 17 is a side view of portions of a latch including a solenoid according to further embodiments of the invention disclosed herein.

FIG. 18 is a side view of a mounting device of a latch according to embodiments of the invention disclosed herein.

FIG. 19 is a top view of the mounting device of FIG. 18 according to embodiments of the invention disclosed herein.

FIG. 20 is a side view of the opposite side of the mounting device of FIG. 18 according to embodiments of the invention disclosed herein.

FIG. 21 is a bottom view of the mounting device of FIG. 18 according to embodiments of the invention disclosed herein.

FIG. 22 is a side view of portions of the latch in an initial position according to embodiments of the invention disclosed herein.

FIG. 23 is a side view of portions of the latch shown in FIG. 22 in a partially withdrawn position according to embodiments of the invention disclosed herein.

FIG. 24 is a side view of portions of the latch shown in FIG. 22 in a withdrawn position according to embodiments of the invention disclosed herein.

### DETAILED DESCRIPTION

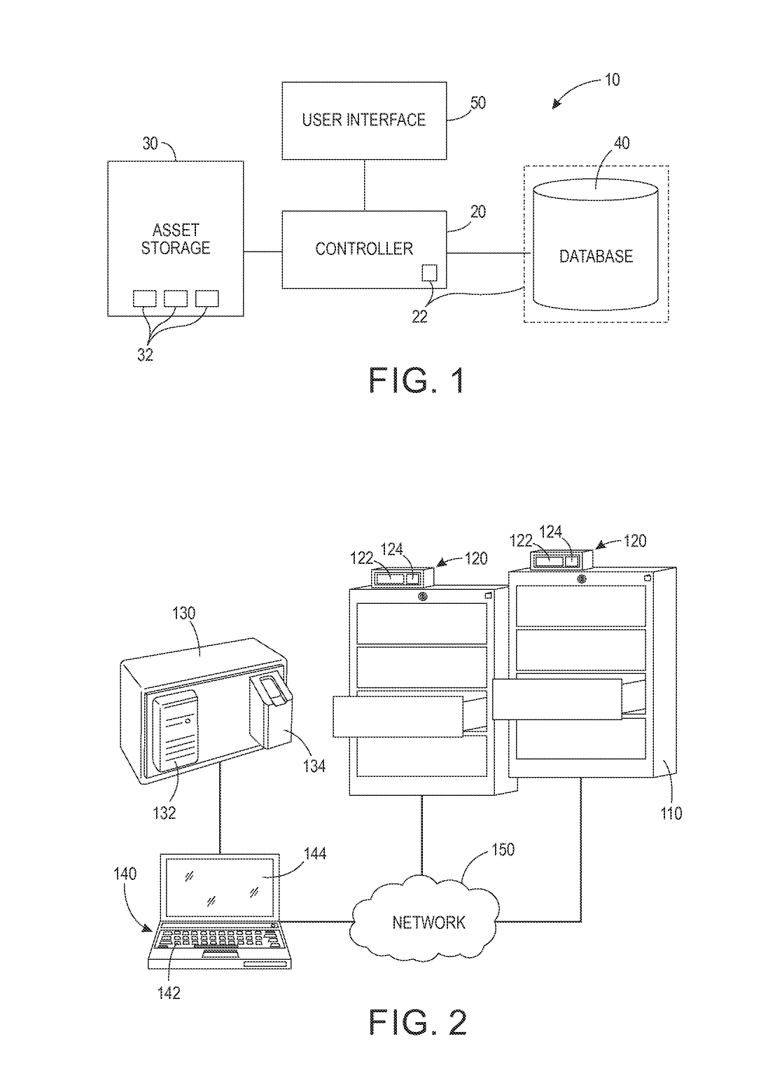

With reference now to FIG. 1, a secure asset management system 10 can include a controller 20 that can monitor asset storage 30 in which assets 32 can be stored. In embodiments, the presence of one or more assets 32 can be monitored and/or detected by controller 20, and controller 20 can use a database 40 to determine whether access should be granted to an asset 32 in asset storage 30. Database 40, as well as software and/or computer program products that can be used to run secure asset management system 10, can be stored on at least one non-transitory computer readable storage medium 22, which can be part of controller 20, can be a standalone device, and/or can be part of another device with which controller 20 can communicate. A user interface 50 can be used to interact with secure asset management system 10 so that administrators can set up, monitor, and/or manage assets 32 with system 10, and so that users can request and/or gain access to assets 32. For example, user interface 50 can include one or more displays, input devices, audio input/output devices, indicator lights, and/or any other device that allows a user to interact with system 10.

FIG. 2 shows a particular implementation of a secure asset management system 100 in which one or more file cabinets 110 can be monitored and/or access thereto can be controlled, such as via one or more control boxes 120, which can be mounted thereon. Each control box 120 can include part of a user interface of secure asset management system 100, which can include a display 122 and/or an input device 126, such as a keypad, for each control box 120. In embodiments, the user interface of secure asset management system 100 can also include a reader 130, which can include a proximity card reader 132, a fingerprint reader 134, and/or any other suitable device to read a security token and/or biometric identifier, though such devices can also be included in any control box(es) 120 as may be desired. Thus, the user interface 50 schematically illustrated in FIG. 1 need not be part of only one device of system 10 or system 100, but, as seen in FIG. 2, can include components of various devices of system 100. Similarly, the controller 20 schematically shown in FIG. 1 can be distributed among several devices of, for example, system 100 of FIG. 2, such as control boxes 120, reader 130, a computer 140, and/or any other suitable device as may be desired, which can communicate via a network 150. In embodiments, network 150 can take the form of a wired network and/or a wireless network as may be suitable and/or desired. Computer 140 can include one or more input devices 142 and/or a display 144 so that a user can interact with SAM 100.

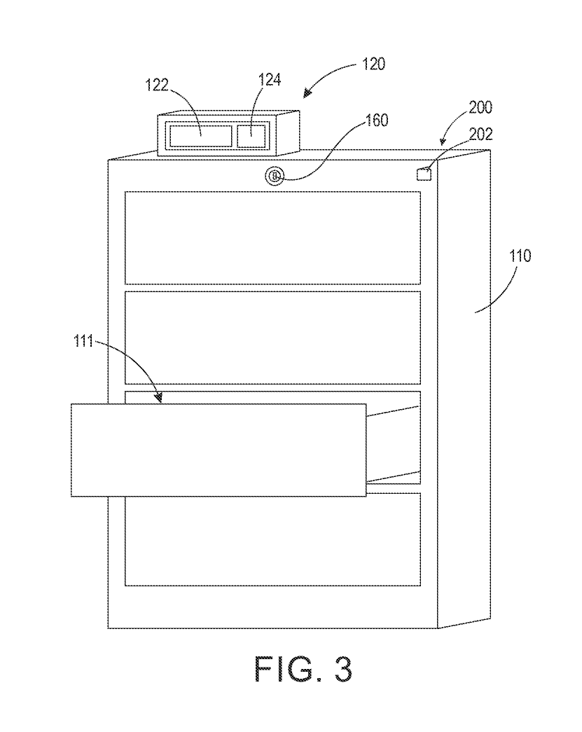

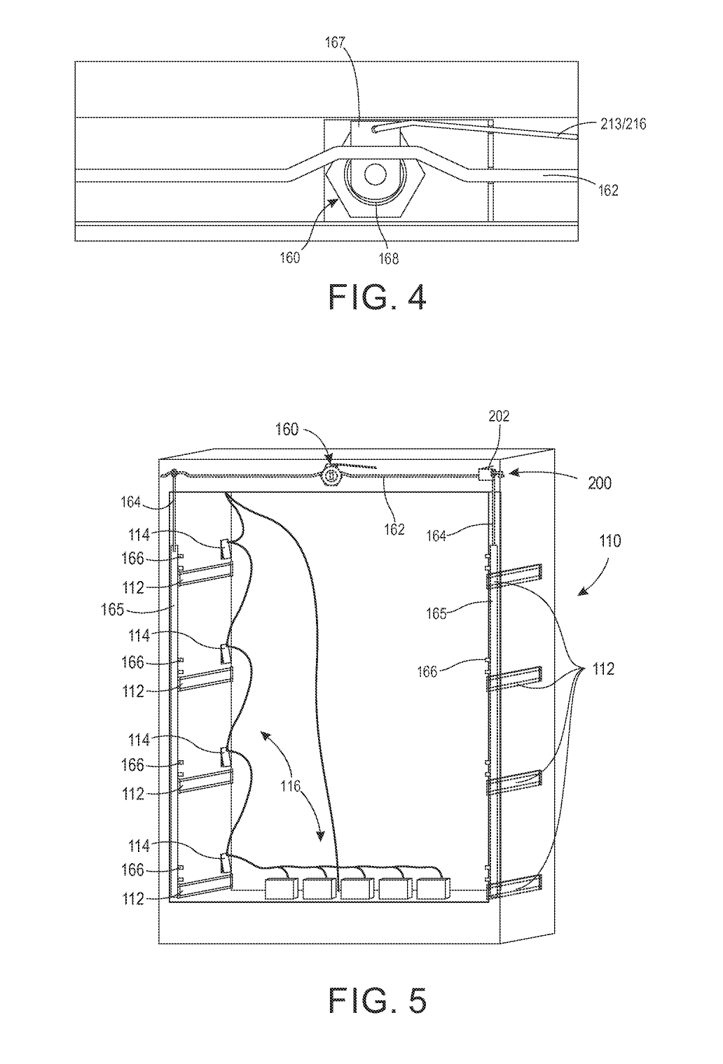

Turning now to FIG. 3, each file cabinet 110 can include one or more drawers 111 which can be locked in a closed position with a lock 160. In embodiments, drawers 111 can additionally be locked and/or unlocked with latch 200 responsive to control box 120 and/or a remote controller or portion thereof. For example, a user could use computer 140 to unlock and/or lock file cabinet 110 with latch 200 using components in file cabinet 110 as will be described. FIG. 4 shows a view of the back of lock 160, which can include conventional parts in addition to those of embodiments and can be operated with a key to lock and unlock file cabinet 110 in known fashion. For example, lock 160 include a rod 162 configured to move substantially vertically responsive to lock 160 so that, with additional reference to FIG. 5, an upright 164 can be lifted, which can lock drawer(s) 111 by sliding a tab 166 on upright 164 into a slot (not shown) of drawer 111. In embodiments, upright 164 can act as a mechanical linkage, as can rod 162, to lift an upright slide 165 slidingly mounted on file cabinet 110, which can bear tab(s) 166 so that drawer(s) 111 can be locked when upright slide 165 is lifted by upright 164. It should be noted that file cabinet 110 can include uprights 164 and/or slides 165 and/or upright slides 166 on one or both sides of drawer(s) 111, and that in embodiments, upright 164 can be lifted by cam action as a result of horizontal motion of rod 162, and that further mechanical linkages can be used as may be desired and/or suitable. Further, locking need not be achieved by lifting tab 166, but could be achieved by lowering tab 166 or allowing it to be lowered, or other motion can be used within the scope of embodiments.

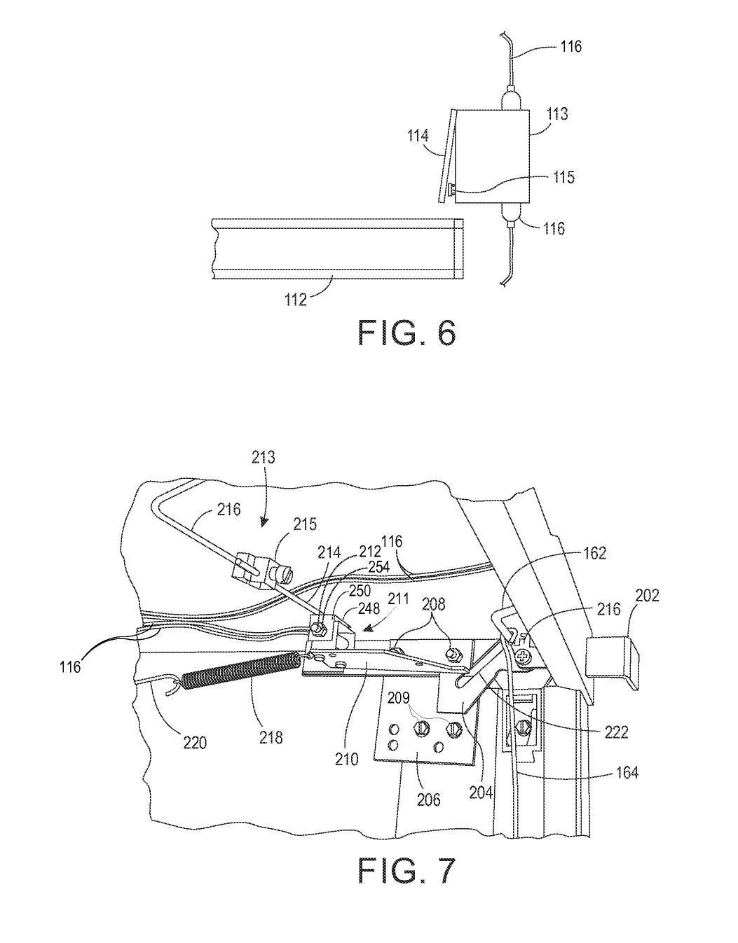

As also seen in FIG. 5, file cabinet 110 can include runners 112 or the like that can guide drawers 111. In embodiments, each drawer 111 can be guided by a pair of runners 112, and a drawer sensor 113 can be included behind one of each pair of runners 112, which can be configured to detect when drawer 111 is closed. For example, as particularly seen in FIG. 6, sensor 113 can be a switch with a lever 114 that can be pressed when drawer 111 is closed, which can change the position of an actuator or the like 115 of sensor 113. When sensor 113 is in communication with control box 120, reader 130, and/or computer 140, such as via wiring 116, the change of position of actuation button 115 can be used to sense whether drawer 111 is open or closed. While the example shown in FIG. 6 shows sensor 113 as a switch that can be wired either normally open or normally closed, a switch with one wiring option can be used instead, and/or another type of sensor can be employed. Where sensor 113 is a switch, however, embodiments can have the switch being normally open so that when drawer 111 is closed, lever 114 closes the switch, but in other embodiments the switch can be normally closed so that when drawer 111 is closed, lever 114 opens the switch. Further, while lever 114 is shown as an actuator for actuation button 115, it could take a different form, such as a roller, it could be omitted, and/or sensor 113 and/or lever 114 and/or actuation button 115 could be included in runner 112 or elsewhere as may be suitable and/or desired. In any case, wiring 116 can be connected to control box 120, reader 130, computer 140, and/or another part of system 100, such as via connectors 118, though it should be understood that embodiments can use wireless communication instead or and/or combined with wired communication. Where multiple drawers 111 are present in file cabinet 110, sensor(s) 113 can be used to determine a status of each drawer 111. Sensor(s) 113 can thus send a signal to control box 120 when drawer(s) 111 is open and/or when drawer(s) 111 so that access thereto can be logged and/or indicated and/or controlled. For example, where sensor 113 is a switch that is closed by opening a drawer 111, a signal can be sent to control box 120 indicating that the particular drawer 111 has been opened. If the opening was unauthorized, then control box 120 can log the unauthorized access, send a notification to security personnel, set off an alarm, and/or take other action as may be suitable and/or desired.

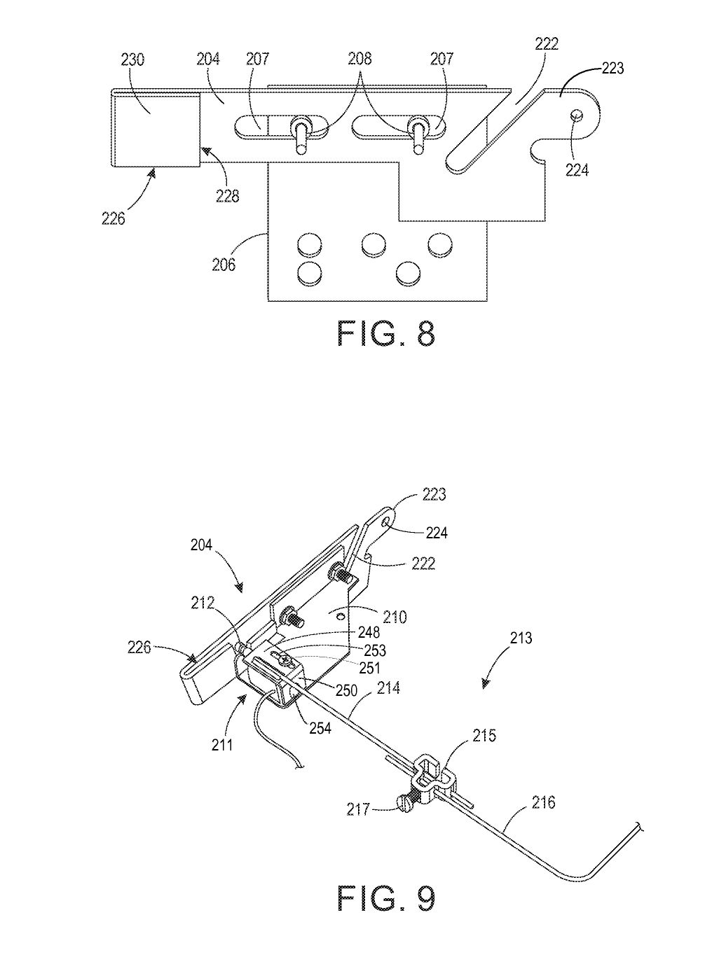

Turning now to FIG. 7, latch 200 can include manual actuator 202, such as a tab, which can be attached to or can be part of a slide 204 attached to file cabinet 110 by a bracket 206 and screws or the like 208. Bracket 206 can in turn be attached to file cabinet 110 by attachment devices 209, which can take the form of screws, bolts, rivets, or any other suitable attachment devices. Screws 208 can likewise be replaced by any suitable attachment device. Slide 204 can be mounted so that manual actuator 202 can translate toward and away from file cabinet 110, corresponding to slide 204 translating and/or moving and/or sliding into and out of file cabinet 110, respectively, with a limited amount of travel as will be explained below. In embodiments, slide 204 can be biased into file cabinet 110 by a spring 218, which can be connected directly to file cabinet 110 and/or can be connected to file cabinet 110 via a spring rod 220. More specifically, with additional reference to FIG. 8, slide 204 can include one or more slots 207 through which screws 208 can extend, slot(s) 207 being sized in length according to a desired amount of travel of slide 204. Thus, when slide 204 is translated, engagement of screw(s) 208 by an end of slot(s) 207 will stop slide 204 in either direction.

Returning to FIG. 7, screws 208 can also support a solenoid mount 210 on which a solenoid 211 can be affixed or otherwise mounted. With additional reference to FIG. 9, solenoid 211 can include a pin 212 and can be mounted so that pin 212 can interfere with slide 204, obstructing translation of slide 204 in a locked state and allowing translation of slide 204 in an unlocked state. Thus, solenoid 211 and/or pin 212 can prevent unlocking of drawer(s) 111 in the locked state and can allow unlocking of drawer(s) 111 in the unlocked state. In embodiments, pin 212 can enter an unlocked state when solenoid 211 is energized and/or when pin 212 is drawn away from slide 204, and can enter the locked state when solenoid 211 is de-energized and/or pin 212 moves and/or is biased toward slide 204. Pin 212 can be attached to a mechanical linkage 213, which, with additional reference to FIG. 4, can be connected to lock 160 so that when lock 160 is unlocked, pin 212 can be mechanically drawn away from slide 204 and into the unlocked state until lock 160 is locked again. In the example shown in FIG. 4, lock 160 can include a flange 167 to which linkage 213 can be attached and that can be attached to a cylinder 168 of lock 160. When cylinder 160 is rotated, such as by a key in lock 160, flange 167 can revolve about a center of rotation of cylinder 168, which can move linkage 213 and change the state of pin 212.

As can be seen in FIGS. 4, 7, and 9, linkage 213 can include multiple portions, which can allow adjustment of relative positions of portions of linkage 213, as well as travel and the like provided by flange 167 and linkage 213. For example, a first portion 214 of linkage 213 can be connected to pin 212 at one end and can extend into a coupling 215 at an opposite end. The connection to pin 212 can include a top bracket 248 slidably attached to solenoid 211, such as with a screw 251 (FIG. 9) through a slot 253 (FIG. 9) formed in top bracket 248. Top bracket 248 can include a back pin guide 250 through which pin 212 can slidingly project, and an end flange 254 of pin 212 can limit travel of pin 212 toward slide 204 by engaging back pin guide 250 so that movement of top bracket 248 away from slide 204 moves pin 212 away from slide 204, but pin 212 can slide through back pin guide 250 during normal operation.

An end of second portion 216 of linkage 213 can extend into coupling 215 and an opposite end of second portion 216 can be attached to flange 167, though additional portions and/or couplings can be included as may be suitable and/or desired. Coupling 215 can retain the ends of first and second portions 214, 216, such as with a set screw 217 or the like, which can also allow adjustment of the relative positions of the ends of first and second portions 214, 216, though other couplings and/or retention arrangements can be used. In embodiments, slide 204, solenoid 211, and/or pin 212 can be construed as mechanical linkages. With this arrangement, rotation of cylinder 168 of lock 160 in one direction moves an end of flange 167 away from slide 204, which moves mechanical linkage 213 away from slide 204, which pulls top bracket 248 away from slide 204, which pulls pin 212 away from slide 204 via back pin guide 250.

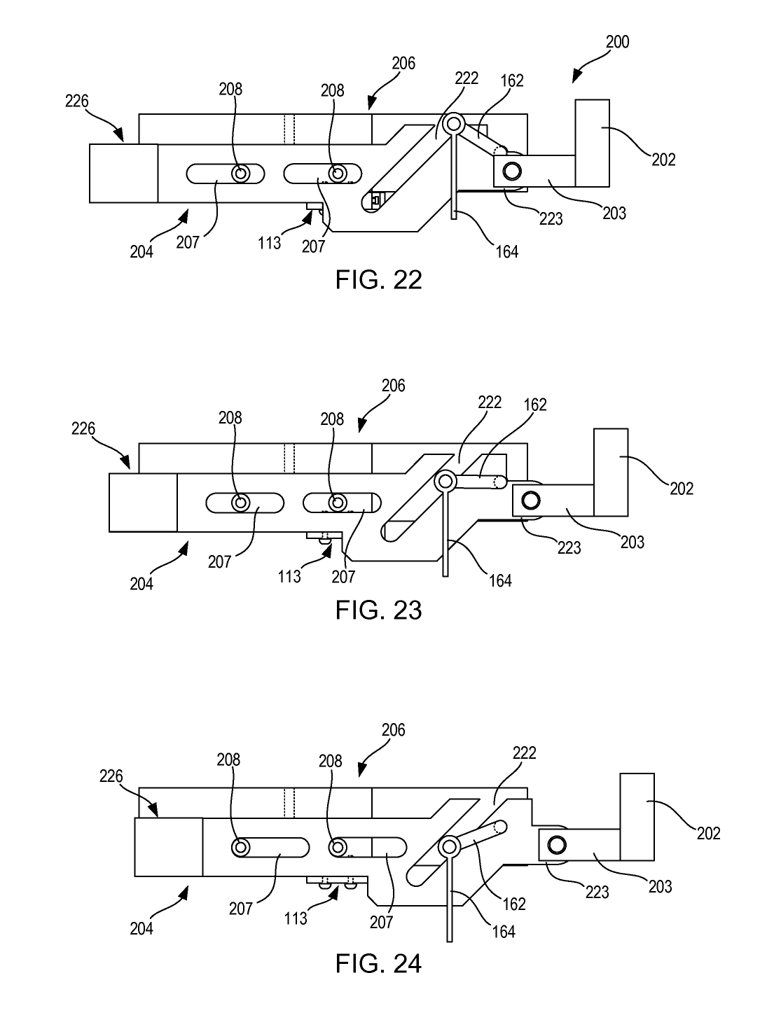

As can be seen in FIGS. 7-9, slide 204 can include a slot 222 sized to receive rod 162 and angled so as to lift rod 162 when slide 204 moves into file cabinet 110, which lifts upright 164 and/or upright slide 165, and moves each tab 166 into a respective slot of a respective file drawer 111, thereby locking the respective drawer 111. Slide 204 can also include a tongue 223 having a substantially flat surface that can engage rod 162 when slide 204 is at or near its furthest point within file cabinet 110, thus pushing and holding rod 162 in its raised and/or locked position. Thus, with pin 212 in the unlocked state, when manual actuator 202 is pulled, translation of slide 204 out of file cabinet 110 lowers rod 162, which can be seen in FIGS. 22-24 that will be described in more detail below, to unlock drawer(s) 111. In embodiments including spring 218, slide 204 can be pulled back into file cabinet 110 upon release of manual actuator 202 so that file cabinet 110 can be locked automatically. Manual actuator 202, as suggested above, can be formed as one piece with slide 204 in embodiments, but can also be formed as a separate piece and attached to slide 204, such as with hole 224 seen particularly in FIG. 8.

As best seen in FIGS. 8 and 9, slide 204 can include a detent 226 configured to be engaged by pin 212 so as to prevent translation when solenoid 211 is in the locked state, but to allow translation when solenoid 211 is in the unlocked state. More specifically, detent 226 can include a shoulder 228 configured to engage a side of pin 212, as well as a surface 230 configured to engage an end of pin 212, which can be biased toward surface 230. In embodiments, slide 204 can be formed from a thin piece of metal, and detent 226 can be a portion of the thin piece of metal that is bent back against the rest of the piece of metal, an end of the piece of metal becoming shoulder 228. Detent 226 can take any other form as may be suitable and/or desired, however.

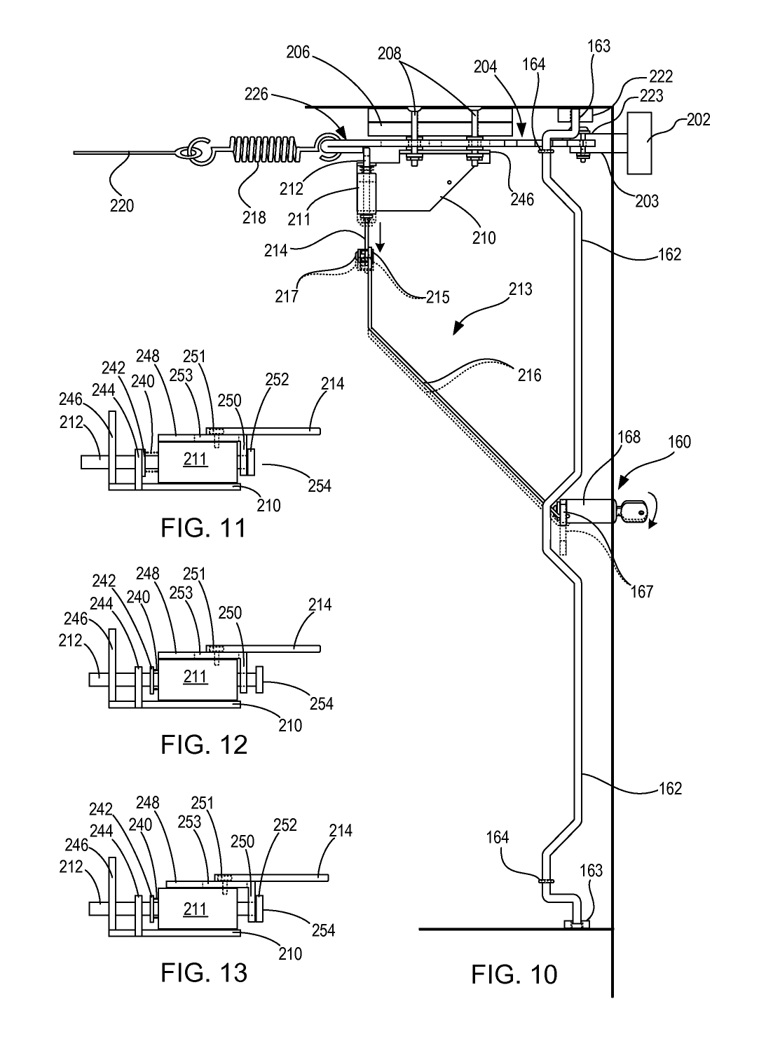

Another view of an embodiment of the invention disclosed herein is shown in FIG. 10, which shows the connection between the solenoid and the cabinet lock, albeit not to scale. In addition, FIG. 10 illustrates the operation of the wire release to mechanically override latch 202. The usual position of mechanical linkage 213 is shown in solid lines, while the override position is shown in dashed lines. Thus, when flange 167 rotates from the initial or normal position shown in solid lines to the override position shown in dashed lines, linkage second portion 216 is pulled away from latch slide 204, pulling linkage first portion 214 away from slide 204, which pulls solenoid pin 212 out of interference with detent 226. To enable normal operation of pin 212 when mechanical linkage 213 is in its normal position, with additional reference to FIGS. 11-13, linkage first portion 214 can be attached to solenoid 211 so as to allow pin 212 to travel as will be explained below.

Pin 212 can be biased toward slide 204 by a spring 240, here shown as being mounted for compression between the body of solenoid 211 and a flange 242 carried on and with pin 212. Thus, as pin 212 is moved away from the slide, spring 240 can be compressed and can urge pin 212 back toward slide 204. Solenoid mount 210 can include a guide 244 through which pin 212 can slidably extend so that guide 244 can aid in keeping pin 212 in a desired path substantially along its longitudinal axis. Solenoid mount 210 can also include a slide flange 246 through which screws 208 can extend to attach solenoid mount 210 to bracket 206 and cabinet 110.

FIGS. 11-13 further illustrate the interaction of solenoid pin 212 with mechanical linkage 213 and example of an arrangement to allow normal operation of pin 212 while providing a mechanical override. A top bracket 248 can be attached to solenoid 211 or to mount 210 and can include a back pin guide 250 through which solenoid pin 212 can slidably extend. Top bracket 248 can be slidably attached, such as to solenoid 211, with a screw 251 extending through a slot 253. Travel of pin 212 toward slide 204 can be limited in part by a pin end flange 254 engaging back pin guide 250, and linkage first portion 214 can be directly attached to top bracket 248. When mechanical linkage 213 is moved to the override position, linkage first portion 214 draws top bracket 248 away from slide 204 so that top bracket 248 slides away from slide 204 and back pin guide 250 pulls pin 212 away from slide 204. While in the normal position, however, pin 212 simply slides back and forth unimpeded by back pin guide 250.

Three different states are shown in FIGS. 11-13 to illustrate operation. In FIG. 11, linkage first portion 214 is in its normal position and pin 212 is in its locked position in which it interferes with detent 226 (FIG. 10). In FIG. 12, pin 212 is moved to its unlocked position by operation of solenoid 211, so that spring 240 is compressed and pin end flange 254 moves out of engagement with back pin guide 250. FIG. 13 shows pin 212 pulled into its unlocked position by back pin guide 250 when linkage first portion 214 moves to the override position.

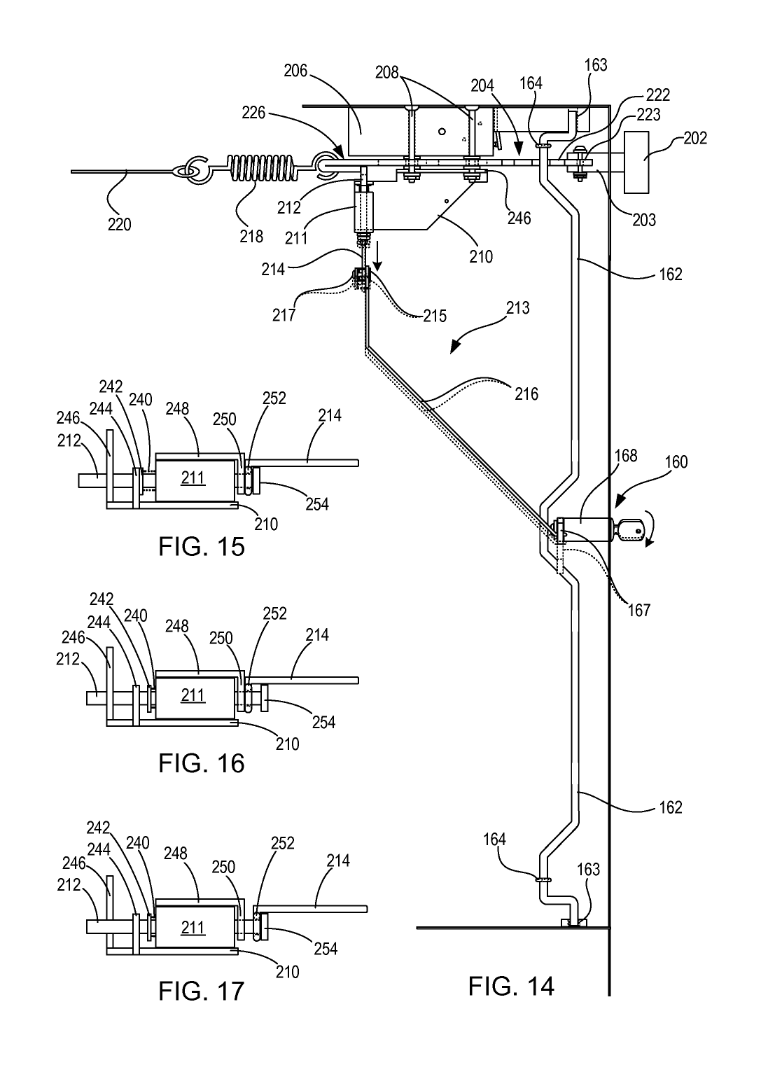

FIGS. 14-24 illustrate another example of the latch and mechanical override in which bracket 206 is thickened and includes a mount 163 for rod 162. As seen in FIGS. 14-17, top bracket 248 can be attached to solenoid 211 or to mount 210 and can include a back pin guide 250 through which solenoid pin 212 can slidably extend. However, in this example, top bracket 248 can be non-slidably attached to solenoid 211 and not directly attached to linkage first portion 214. Rather, linkage first portion 214 includes or is attached to a linkage pin guide 252 through which pin 212 can slide, against which a pin end flange 254 abuts, which can engage back pin guide 250, and which can move with linkage first portion 214. Thus, when linkage 213 is in the normal position, pin 212 can slide unimpeded through back pin guide 250 and linkage pin guide 252. When linkage 213 is moved to the override position, linkage first portion 214 pulls linkage pin guide 252 away from slide 204, which pulls pin 212 away from slide 204 via pin end flange 254.

Three different states are shown in FIGS. 15-17 to illustrate this operation. In FIG. 15, linkage first portion 214 is in its normal position and pin 212 is in its locked position in which it interferes with detent 226 (FIG. 10). In FIG. 16, pin 212 is moved to its unlocked position by operation of solenoid 211, so that spring 240 is compressed and pin end flange 254 moves out of engagement with linkage pin guide 252. FIG. 17 shows pin 212 pulled into its unlocked position by linkage pin guide 252 when linkage first portion 214 moves to the override position.

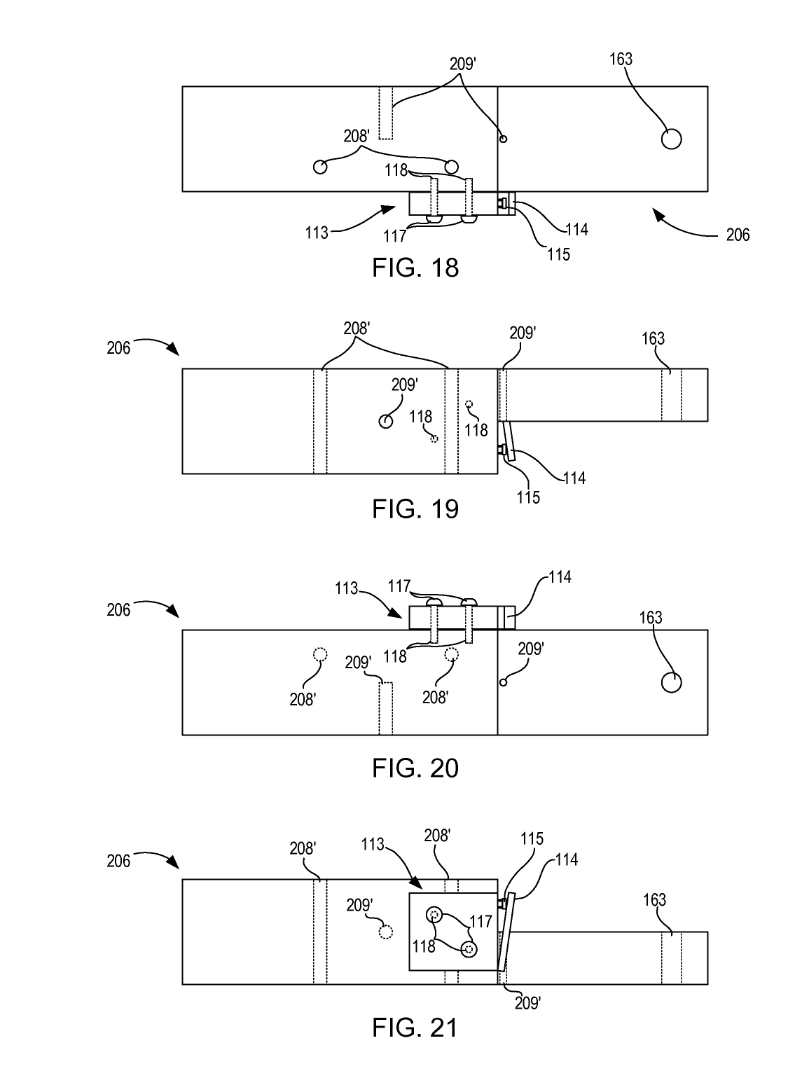

FIGS. 18-21 illustrate an example of the variant of bracket 206 used in the example of FIGS. 14-17. More specifically, bracket 206 can include through holes 208′ through which screws 208 (FIG. 14) can be inserted. In addition, bracket 206 can include mounting holes 208′ parallel to multiple axes to secure bracket 206 to cabinet 110. As seen in FIGS. 14 and 18-21, bracket 206 can include a pivot point or mount 163 for rod 162, in which an end of rod 162 can be rotatably held.

FIGS. 22-24 illustrate the relative motion of slide 204 and rod 162 during operation of latch 200. Slide 204 is in or near a locked position in FIG. 22, and rod 162 is held in a locked position by slide 204, which results in upright(s) 164 and upright slide(s) 165 (FIGS. 5 and 7) being held in a locked position in which tab(s) 166 (FIG. 5) can lock drawers 111 closed. In FIG. 23, slide 204 is in an intermediate position in which rod 162 is lower than the locked position of FIG. 22, but higher than an unlocked position. As can be seen, rod 162 engages slide 204 further down slot 222 than it does in the locked position of FIG. 22 so that upright(s) 164, as well as upright slide(s) 165 and tab(s) 166 (FIG. 5), being in a lower position than that of FIG. 23. FIG. 24 shows slide 204 in or near an unlocked position in which rod 162 engages slide 204 at a position further down slot 222 than in either the locked or intermediate positions of FIGS. 22 and 23. As a result, upright(s) 164 is in a lower position than in FIGS. 22 and 23, so that upright slide(s) 165 (FIGS. 5 and 7) are also in lower positions and tab(s) 166 are in an unlocked position.

One result of this variant of bracket 206 is that a single sensor 113 can be used to determine whether a drawer 111 of cabinet is open. As with previously-described sensors 113, a lever 114 can engage an actuator or button 115 that biased out of the housing of sensor 113. Here, however, sensor 113 can be mounted on bracket 206 so that latch bracket 203 depresses lever 114 fully when slide 204 is in the locked position. When a drawer 111 is open, upright slides 165 and upright 164 are held against rising to the locked position by the action of slides 112, and this prevents rotation of rod 162 out of the unlocked position. Rod 162 can then hold slide 204 in an unlocked state by virtue of the rod's engagement with slide 204 in slot 222. When no drawer 111 is open, tabs 166 are able to slide up into their locked position so that the action of spring 218 can pull slide 204 toward its locked position, which can lift rod 162 into its locked position, lifting upright 164, upright slide 165, and tabs 166 into locked positions, and actuator 202 and slide 204 can return to their locked positions. Thus, if a drawer 111 is open, sensor 113 is not activated by slide 204 since slide 204 is held in an unlocked state, but if all drawers 111 are closed, slide 204 can return to the locked state and sensor 113 is activated. It should be apparent that a sensor could be employed that operates in an opposite manner than that described above so that sensor 113 is activated when any drawer 111 is open, but is not activated when all drawers 111 are closed.

As can particularly be seen in FIGS. 22-24, slide 204 can have a different layout than that shown in FIGS. 7-10. The top of slide 204 is at substantially the same level all along slide 204 in the example of FIGS. 7-10, with a top of tongue 223 being flush with the top of slide 204. However, in FIGS. 22-24, slide 204 can have the mouth of slot 222 in a higher portion of the top surface of slide 204, with tongue 223 projecting from a lower level of slide 204. Of course, the particular level of the top surface of slide 204 and the location of tongue 223, as well as the thickness and layout of bracket 206, can vary as may be needed to fit a given file cabinet and its locking system, and such variation is within the scope of embodiments.

In operation, a user can request access to an asset in a file cabinet 110 in a number of ways. For example, the user can activate a control box 120 and provide some form of authentication, such as a password or personal identification number, a radio frequency identification card, a magnetic stripe card, a fingerprint, a retina, and/or any other form as may be accepted by system 100. The authentication can be provided at a different control box 120, at reader 130, at computer 140, and/or in any other suitable manner in embodiments as appropriate. With proper authentication, the system controller can energize solenoid 211 to pull pin 212 away from slide 204, pin 212 sliding through back pin guide 252. This pulls pin 212 out of interference with detent 226 so that the user can pull on manual actuator 202 to move slide 204 out of file cabinet 110. Moving slide 204 out of file cabinet 110 unlocks drawer(s) 111 so that the user can retrieve an asset stored therein. In the particular example shown, as slide 204 moves out of file cabinet 110, rod 162 enters and slides down groove 222, lowering upright 164 and/or upright slide 165. As a result, tab 166 disengages drawer(s) 111, which the user can open to retrieve an asset stored therein. Where spring 228 is included, as soon as the user releases manual actuator 202, slide 204 is withdrawn into file cabinet 110 until shoulder 228 passes pin 212, which then moves into interference with shoulder 228, locking drawer(s) 111 that aren't open and, with proper configuration of tab 166, locking any open drawer 111 as soon as the drawer is closed. Control box 120 can monitor changes to the state(s) of drawer(s) 111 via respective sensor(s) 113 as described above and can use this information in the control of file cabinet 110 and/or latch 200.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A file cabinet latch comprising:
a first manual actuator configured to protrude from a file cabinet and to translate away from and toward the file cabinet; and
at least one mechanical linkage configured to operate a locking system of the file cabinet responsive to translation of the first manual actuator such that moving the first manual actuator away from the file cabinet unlocks at least one drawer of the file cabinet and moving the first manual actuator back toward the file cabinet locks any closed drawer of the file cabinet.

2. The file cabinet latch of claim 1, further comprising a solenoid with a pin configured to prevent translation of the first manual actuator in a locked state of the solenoid and to allow translation of the first manual actuator in an unlocked state of the solenoid.

3. The file cabinet latch of claim 2, wherein the solenoid is responsive to a controller such that, responsive to authentication of a user requesting access to contents of the file cabinet, the controller can place the solenoid in the unlocked state.

4. The file cabinet latch of claim 2, wherein the file cabinet includes a lock and the at least one mechanical linkage includes a solenoid linkage connected to the pin of the solenoid and configured to move the pin out of interference with the first manual actuator when the lock is unlocked.

5. The file cabinet latch of claim 4, wherein the solenoid linkage includes a first portion connected to the pin of the solenoid, a second portion connected to the lock, and a coupling retaining ends of the first and second portions.

6. The file cabinet latch of claim 5, further comprising a flange attached to a cylinder of the lock, the second portion being attached to the flange such that rotation of the flange translates the second portion, which translates the coupling and the first portion to move the pin out of interference with the first manual actuator.

7. The file cabinet latch of claim 1, wherein the first manual actuator includes a tab outside the file cabinet attached to a slide in the file cabinet, the slide having a groove sized to receive a rod of the file cabinet and angled with a lower, closed end farther than a higher, open end from the tab, the groove thereby being configured to allow the rod to move down when the tab is moved away from the file cabinet, thereby unlocking at least one drawer of the file cabinet, and to lift the rod when the tab is moved back toward the file cabinet, thereby locking any closed drawer of the file cabinet.

8. A secure asset management system comprising:
a controller including at least one computing device configured to receive an authentication request, to receive authentication information, and to grant access to an asset responsive to a match between the authentication information and an authentication reference;
a user interface configured to allow interaction with the controller to request access to the asset and to provide the authentication information;
a file cabinet including a drawer in which the asset is stored; and
a latch for the file cabinet that unlocks the drawer responsive to the controller granting access to the asset.

9. The secure asset management system of claim 8, wherein the latch includes a solenoid with a pin configured to prevent unlocking the drawer in a locked state of the solenoid and to allow unlocking of the drawer in an unlocked state of the solenoid.

10. The secure asset management system of claim 9, wherein the latch includes at least one mechanical linkage configured to operate a locking system of the file cabinet and the pin is configured to interfere with operation of the locking system in the locked state of the solenoid.

11. The secure asset management system of claim 10, wherein the at least one mechanical linkage includes a slide configured to unlock the drawer when the slide is translated in a first direction and to unlock the drawer when the slide is translated in a second direction.

12. The secure asset management system of claim 11, wherein the slide includes a groove sized to receive the rod, the groove including a closed lower end and an open upper end, the lower end being farther than the upper end from a front wall of the file cabinet.

13. The secure asset management system of claim 9, further comprising a sensor in communication with the controller and configured to detect whether the drawer is open.
